(19) United States
(12) Patent Application Publication
(10) Pub. No.: US 2007/0210177 A1
(43) Pub. Date: Sep. 13, 2007

(54) Programmable thermostat

(76) Inventor: Jan Karasek, Aurora, CO (US)

Correspondence Address: COOLEY GODWARD KRONISH LLP;ATTN: PATENT GROUP, Suite 500, 1200 - 19th Street, NW, WASHINGTON, DC, 20036-2402, US

(21) Appl. No.: 11/373,475

(22) Filed: Mar. 10, 2006

(51) Int. Cl. F23N 5/20; G05D 23/00

(52) U.S. Cl. 236/46 R

(57) ABSTRACT

A system and method for programming a thermostat is described. One embodiment includes a method for communicating a thermostat operation schedule to a media device that then communicates the thermostat operation schedule to a thermostat. An additional embodiment includes a computer readable medium encoded with executable instructions for establishing computer-readable code that effects operation of a thermostat. In yet another embodiment, a thermostat is included that operates upon computer-readable code to execute an operation schedule.

### COPYRIGHT

A portion of the disclosure of this patent document contains material that is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE INVENTION

The present invention relates to computer software applications. In particular, but not by way of limitation, the present invention relates to systems and methods for programming a thermostat using a media device comprising executable instructions.

### BACKGROUND OF THE INVENTION

Thermostats are available in two forms. One is mechanical, where the movement of a dialing tool sets the temperature at a fixed level until the next change is executed. The other is programmable. Programmable thermostats automatically adjust temperature settings in buildings; thus allowing for conservation of energy during time periods when those buildings are not in use. The automatic adjustments ensure a consistent use of less energy, advantageously resulting in economic savings and a reduction of greenhouse gas emissions associated with energy production.

Typically, the primary purpose of a programmable thermostat is to regulate the temperature in a building to maintain a desired comfort level when the building is occupied and then enter an economizing mode when the building is unoccupied. In most cases, the thermostat is programmed on the basis of a future schedule, which is set in advance by a user of the thermostat. The scheduling options vary with each thermostat, but typically operate on hour and/or day intervals. A single schedule may operate throughout the year or may be programmed to operated during specific time periods (e.g., the winter months).

There are several downsides to programmable thermostats in their current state. One issue is the display which serves as a programming screen. The displays are generally limited by the size of the programmable thermostat, which is desirably small for aesthetic and space saving reasons. The small size of displays are difficult to read, while offering limited and confusing programming functions and/or symbols.

Another downside to programmable thermostats is the effort required to learn and master them. Programming a thermostat can be a daunting task, intimidating many users who may hesitate to use the programming capabilities of a thermostat to their full advantage. The more features a programmable thermostat offers usually results in higher complexity. For example, a programmable thermostat that has two modes (e.g., a normal mode when the building is occupied and an economy mode when the building is not occupied) is typically less complex than a programmable thermostat with three modes (e.g., a normal mode when occupants are present and not sleeping in the building, a sleep mode when the occupants are sleeping, and an economy mode when the building is not occupied). Although the additional sleep mode feature may result it additional energy conservation (e.g., the sleep mode may maintain a comfort level lower than the normal mode), it requires that a user learn how to operate that specific mode (and each additional mode).

A third downside to programmable thermostats is the potential loss of a program. If a program were to be lost, a user has to input a new program into the thermostat every time the previous program is erased. This results in user frustration and time inefficiency.

Although present programmable thermostats are functional, they are not sufficiently accurate or otherwise satisfactory. Accordingly, a system and method are needed to address the shortfalls of present technology and to provide other new and innovative features.

### SUMMARY OF THE INVENTION

Exemplary embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents and alternative constructions that fall within the spirit and scope of the invention as expressed in the claims.

The present invention can provide a system and method for programming a thermostat. In one exemplary embodiment, the present invention includes a method wherein a media device connected to a computing device uploads computer-readable code for a thermostat. The media device is then connected to the thermostat so as to enable the thermostat to download the computer-readable code stored on the media device.

In another embodiment, the present invention includes a thermostat that comprises a media reader, a schedule interpreter and a memory device. The media reader is configured to exchange computer-readable code with a portable media device. Some of the computer-readable code is released to the schedule interpreter which executes an operation schedule. The memory device is configured to store operating data and then release the operating data to the portable media device.

In yet another embodiment, the present invention includes a computer-readable medium encoded with executable instructions for establishing a thermostat operation schedule consisting of computer-readable code. The thermostat operation schedule is uploaded to a portable media device from a computing device and is downloaded by a thermostat from the portable media device.

As previously stated, the above-described embodiments and implementations are for illustration purposes only. Numerous other embodiments, implementations, and details of the invention are easily recognized by those of skill in the art from the following descriptions and claims.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings wherein:

FIG. 1 illustrates a system in accordance with an exemplary embodiment of the present invention;

FIG. 2 shows a block diagram of a computing device in accordance with one implementation of the present invention;

FIG. 3 shows a block diagram of a thermostat in accordance with one implementation of the present invention; and

FIG. 4 depicts a process flow diagram in accordance with an exemplary implementation of the present invention.

### DETAILED DESCRIPTION

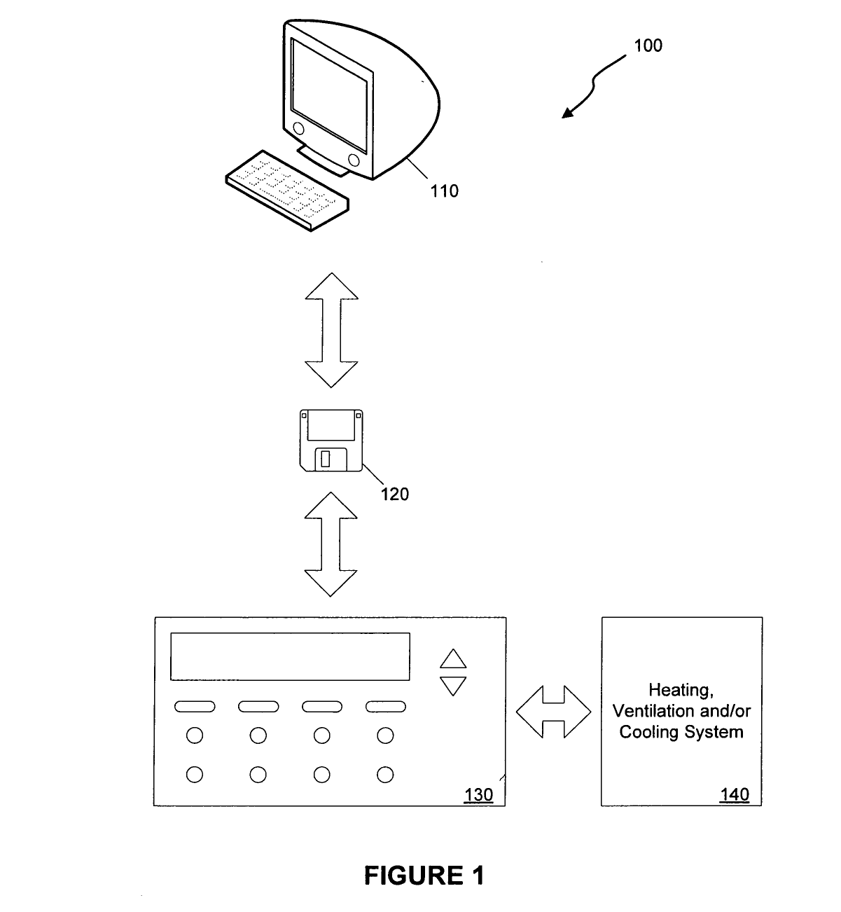

Referring now to the drawings, where like or similar elements are designated with identical reference numerals throughout the several views, and referring in particular to FIG. 1, illustrated is a system 100 in accordance with an exemplary embodiment of the present invention.

According to FIG. 1, a computing device 110 (e.g., a handheld, a notebook or a desktop computing device) communicates with a portable media device 120 (e.g., universal serial bus (USB) card, a memory card (e.g., a flash memory card), a floppy disc). The portable media device 120 in turn communicates with a thermostat 130 which controls a heating, ventilation and/or cooling system 140. The system 140 may be any environmental control system known in the art that is responsive to operation instructions from a thermostat.

In an exemplary embodiment, the system 100 enables a thermostat operation schedule to be programmed at the computing device 110 and then transferred via the portable media device 120 to the thermostat 130 where the operation schedule is executed.

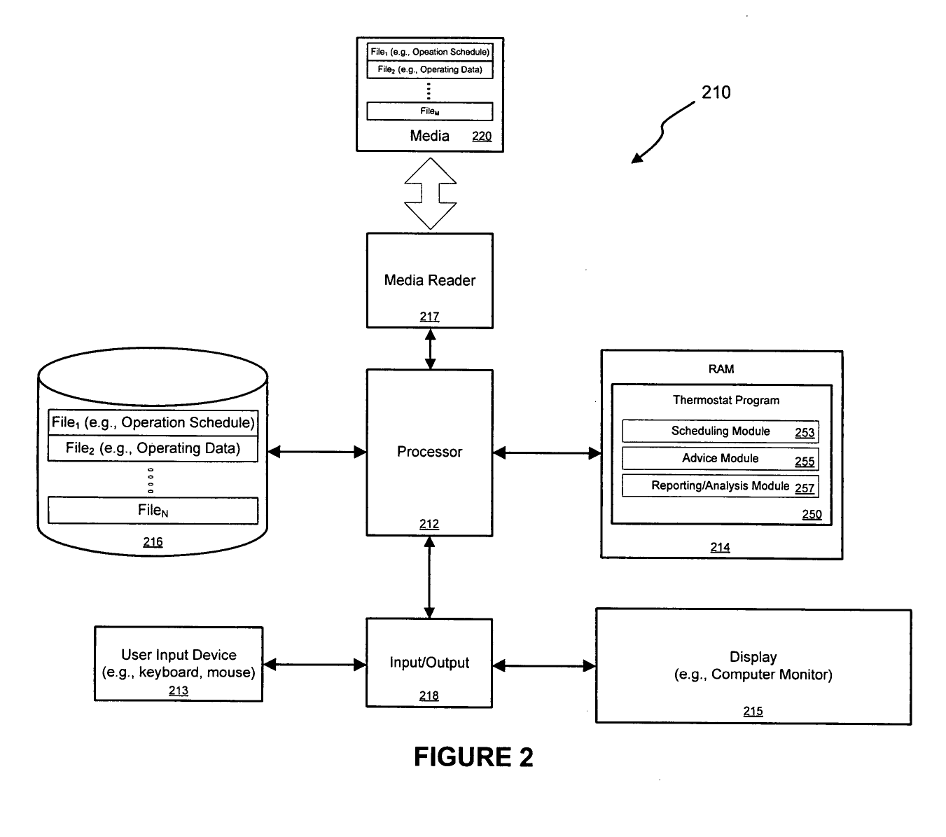

Attention is now drawn to FIG. 2, which shows a block diagram 210 of the computing device 110 in accordance with one implementation of the present invention. The implementation shown in FIG. 2 includes a processor 212 coupled to a memory 214 (e.g., random access memory (RAM)), a file storage device 216, a media reader 217, and an input/output 218 connected to both a user input device 213 (e.g., a keyboard or a mouse) and a display 215 (e.g., a computer monitor).

As shown, the storage device 216 provides storage for a collection of N files. The storage device 216 is described herein in several implementations as hard disk drive for convenience, but this is certainly not required, and one of ordinary skill in the art will recognize that other storage media may be utilized without departing from the scope of the present invention. In addition, one of ordinary skill in the art will recognize that the storage device 216, which is depicted for convenience as a single storage device, may be realized by multiple (e.g., distributed) storage devices.

In an exemplary embodiment, the N files stored in the storage device 216 may include one or more files relating to operation schedule(s) of the thermostat 130. The operation schedule(s) are programmed at the computing device 110 and then loaded onto the media 220 (e.g., the portable media device 120) for transfer to the thermostat 130. In addition to the operating schedule(s), the N files may include operating data received from the thermostat 130 via the media 220.

As shown, a thermostat program application 250 includes a scheduling module 253, an advice module 255, and a reporting/analysis module 257, which are implemented in software and are executed from the memory 214 by the processor 212. The software 250 can be configured to operate on personal computers (e.g., a handheld, a notebook or a desktop), servers or any device capable of processing instructions embodied in executable code. Moreover, one of ordinary skill in the art will recognize that alternative embodiments, which implement one or more components (e.g., the thermostat program application 250) in hardware, are well within the scope of the present invention.

For example only, the thermostat program 250 interacts, via the user input device 213 and the display 215, with a user who wishes to program a thermostat, monitor energy usage and/or receive advice directed at more-efficient use of the system 140.

In one embodiment, the user input device 213 is a keyboard (e.g., a qwerty keyboard). In another embodiment, the user input device 213 may include a mouse or other device that allows the user to select options displayed on the display 215. The display 215 may be any display capable of displaying several lines of text at once (e.g., an LCD, a CRT or other like technology. In several embodiments, the display 215 is capable of displaying color and graphics.

It should be recognized that an operating system (not shown) of the computing device 110 is not limited to any particular type of operating system and may be operating systems provided by Microsoft Corp. under the trade name WINDOWS (e.g., WINDOWS 2000, WINDOWS XP, and WINDOWS NT). Additionally, the operating system may be an operating system such operating systems distributed under the LINUX trade name. For convenience, however, embodiments of the present invention are generally described herein with relation to WINDOWS-based systems. Those of skill in the art can easily adapt these implementations for other types of operating systems or computer systems.

As shown, the media reader 217 is connected to the processor 212. Any device external to the computing device 110 (e.g., the portable media device 120) that communicates with the computing device 110 does so by interfacing with the media reader 217. The media reader 217 may be any peripheral device (e.g., a USB port, a memory card reader, and/or a disk drive) which is configured to communicate with the portable media device 120.

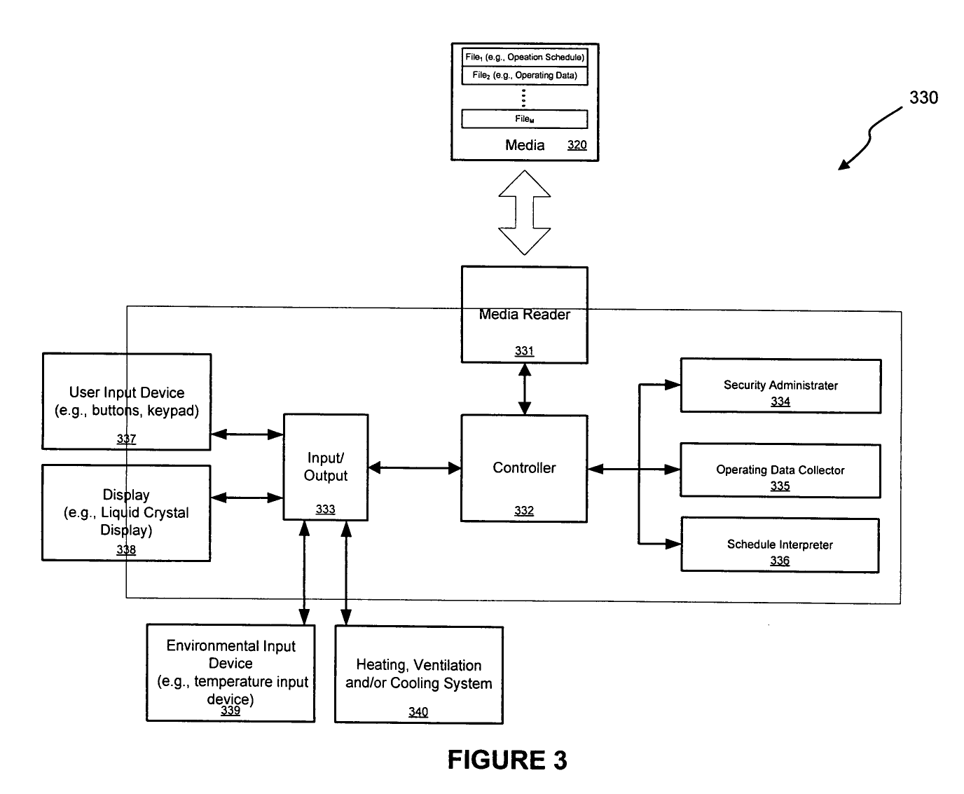

Attention is now drawn to FIG. 3, which shows a block diagram 330 of the thermostat 130 in accordance with one implementation of the present invention. The implementation of FIG. 3 includes a controller 332 coupled to a media reader 331, an input/output 333, a security administrator 334, an operating data collector 335 and a schedule interpreter 336. The input/output 333 is connected to a user input device 337 (e.g., a keypad and/or buttons that allow a user to deliver commands to the thermostat), a display 338 (e.g., a liquid crystal display configured to send messages to a user), an environmental input device 339 and a heating, ventilation and/or cooling system 340 (e.g., the system 140).

The controller 332 is configured to regulate information exchange within the thermostat 330. Although it is shown in this embodiment, the controller 332 is not a necessary component of the present invention. It is included only to clarify the operation of the thermostat 330, which in this embodiment is designed to work independent of the central control systems that may be found in the prior art. Specifically, the thermostat 330 in this embodiment is a unitary thermostat capable of executing an operation schedule in contrast to “dumb” sensors coupled to a centrally administered environmental control system.

Referring again to FIG. 3, the media reader 331 exchanges information (e.g., operation schedule files and operating data files in the form of computer-readable code) with media 320 (e.g., the portable media device 120). An operation schedule file is transferred from the media 320, to the media reader 331, through the controller 332, and then it arrives at the schedule interpreter 336. The schedule interpreter 336 reviews the operation schedule and then releases command signals to the system 340 according to the operation schedule. The schedule interpreter 336 may also receive information from the environmental input device 339 (e.g., temperature readings) and then release command signals to the system 340 in view of that information.

The operating data collector 335 is configured to receive operating data from the environmental input device 339 (e.g., temperature readings), the system 340 (e.g., energy usage, status information), and the schedule interpreter 336 (e.g., schedule-related information like run time). The operating data may be released to the media 320, where it is transferred to the computing device 110 for analysis by the reporting/analysis module 257 of the thermostat program 250.

The security administrator 334 locks access to the thermostat 130 to unauthorized users. Authorization may be administered via the user input device 337/display 338 or by encrypted security code delivered to the thermostat 130 via the media 320. These measures prevent unauthorized or undesired access, especially to thermostat units placed in publicly accessed areas (e.g., hallways, large rooms).

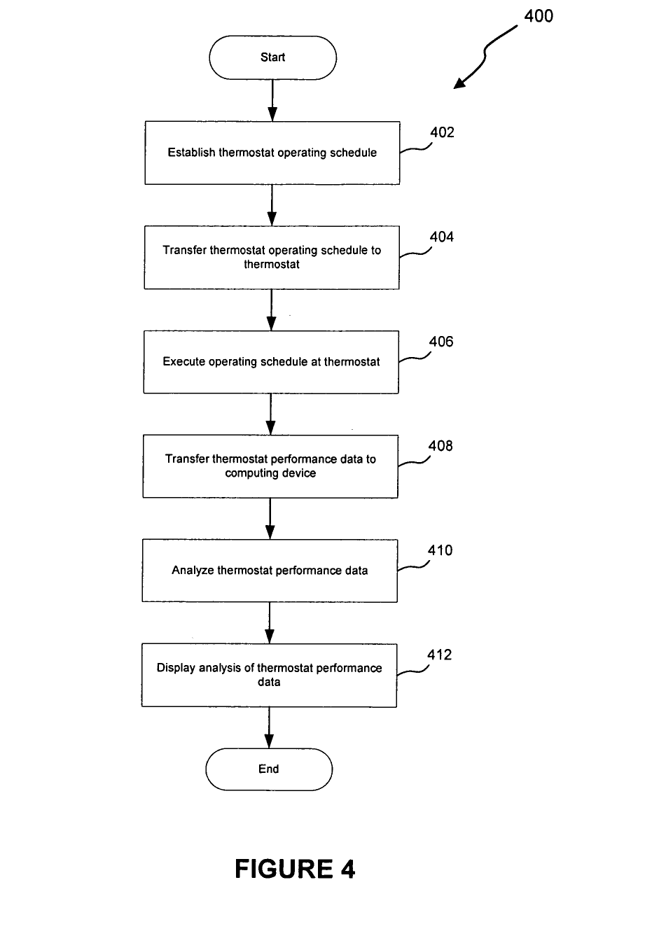

While referring to FIG. 4, simultaneous reference will be given to FIGS. 1-3. Attention is now drawn to FIG. 4, which depicts a process flow diagram 400 in accordance with an exemplary implementation of the present invention. The process depicted in FIG. 4 illustrates an exemplary exchange of information between the computing device 110, the portable media device 120 and the thermostat 130. One of ordinary skill in the art will recognize that additional or fewer steps may be implemented than those shown in FIG. 4.

To start, a user (not shown in any figure) runs the thermostat program 250 in the computing device 110. In an exemplary embodiment, the program 250 is displayed to the user on a large screen (e.g., the display 215) which is capable of delivering images, text, and/or color. The output of the thermostat program 250 on the display 215 represents a departure from previously known thermostat programming in that the program 250 is capable of displaying a greater quantity and/or quality of images, text, color and/or programming options. By transferring the programming of a thermostat to the computing device 110, a user is provided with an easier-to-use interface relative to the small LCD display and small quantity of buttons typically found on unitary programmable thermostats.

After opening the program 250, the user is provided with one or more options. In an exemplary embodiment, a tutorial option is provided to the user via the advice module 255. The tutorial option may provide instructions that enable the user to understand and navigate the applications provided by the program 250. The tutorial option may also provide advice to the user with respect to creating a thermostat schedule. This advice may include prearranged templates and dialog boxes containing educational material that enable the user to create an effective schedule.

In an exemplary embodiment the user is presented with a scheduling option provided by the scheduling module 253. After selecting the scheduling option, the user establishes a thermostat operation schedule (Block 402). In establishing an operation schedule the user may be presented with any number of scheduling options that are known in the art.

Upon creating a schedule, the user saves the schedule (e.g., in the file storage 216) and then transfers the schedule to the thermostat 130 (Block 404). In an exemplary embodiment, the transfer of the schedule to the thermostat 130 passes from the computing device 110 (e.g., via the media reader 217), through the portable media device 120 and then into the thermostat 130. At this point, the thermostat 130 executes the schedule via the schedule interpreter 336 (Block 406). The steps presented in Blocks 402-406 represent the extent of several embodiments of the present invention.

A benefit of many embodiments of the thermostat 130 over previously known thermostats is the ability to be configured to collect and store operating data in the portable media device 120. Such operating data may include status messages, run times of various schedules, energy usage data and temperature data. In the exemplary embodiment described with reference to FIG. 3, the operating data, if it exists, is collected by the operating data collector 335, and then transferred from the thermostat 130 to the portable media device 120 and then to the computing device 110 (Block 408).

Once received by the computing device 110, the reporting/analysis module 257 may begin analysis of the operating data (Block 410). In an exemplary embodiment the analysis may include a graphical display of historical usage and a projected energy bill based on historical use and/or projected future use combined with past and/or expected energy prices (Block 412). Benefits of the analysis include an increased user awareness that may lead to more optimum energy usage or advanced budgeting.

Additional features of the present invention include security measures that lock the access to the thermostat (e.g., the security measures provided via the security administrator 434). These measures may prevent unauthorized or undesired access, especially to thermostat units placed in publicly accessed areas (e.g., businesses, hallways, large rooms).

The program 250 may be configured to download information from the Internet or supplemental computer-readable media. The downloaded information may include updates to the program 250 or useful information that can be implemented by any of the modules 223, 225 and 227.

In conclusion, the present invention provides, among other things, a system and method for programming a thermostat. Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention as expressed in the claims.

What is claimed is:

1. A method for programming a thermostat, comprising:
connecting a portable media device to a computing device;
downloading computer-readable operating schedule information from the computing device to the portable media device;
connecting the portable media device to the thermostat; and
uploading the computer-readable operating schedule information to the thermostat from the portable media device so as to enable the thermostat to operate in accordance with the operating schedule information.

2. The method of claim 1, further comprising:
establishing the computer-readable operating schedule information at the computing device prior to downloading the computer-readable operating schedule information from the computing device to the portable media device.

3. The method of claim 1, further comprising:
uploading thermostat operating data to the portable media device from the thermostat;
downloading the thermostat operating data from the portable media device to the computing device; and
performing analysis of the thermostat operating data using a large screen included with the computing device.

4. The method of claim 1, wherein the uploading the computer-readable operating schedule information to the thermostat from the portable media device comprises:
activating a security feature included in the thermostat to authorize the uploading.

5. The method of claim 2, wherein the establishing is performed at least in part by a large screen included with the computing device.

6. The method of claim 2, wherein the establishing includes establishing the operating schedule information with a qwerty keyboard.

7. The method of claim 1, wherein the portable media device includes a memory.

8. The method of claim 1, wherein the computing device is a computing device selected from the group consisting of a desktop computer and a notebook computer.

9. A thermostat, comprising:
a media reader configured to retrieve computer-readable operating schedule information from a portable media device, wherein the portable media device comprises a memory that stores the computer-readable operation schedule information;
a schedule interpreter that interprets the operation schedule so as to enable the thermostat to execute the operating schedule, wherein the operation schedule is downloaded from the portable media device by way of the media reader.

10. The thermostat of claim 9, including a memory device configured to store operating data indicative of operating history of an environmental system, wherein the operating data is uploaded to the portable media device so as to enable the operating data to be read by a computing device when the portable media device is coupled to the computing device.

11. The thermostat of claim 9, wherein the operation schedule is originally programmed at a remote computing device before being uploaded to the portable media device.

12. The thermostat of claim 10, wherein the operating data is eventually analyzed at a remote computing device that is not connected to the thermostat by way of a wired or wireless connection.

13. A computer-readable medium encoded with executable instructions for:
establishing a thermostat operation schedule consisting of computer-readable code, wherein the thermostat operation schedule is uploaded to a portable media device from a computing device, and wherein the thermostat operation schedule is downloaded by a thermostat from the portable media device so as to enable the thermostat to operate in accordance with the operating schedule.

14. The computer-readable medium of claim 13, wherein the executable instructions further include instructions for storing data on the computing device that was downloaded from the portable media device, wherein the data was originally uploaded from the thermostat and stored on the portable media device, and wherein the data includes historical energy usage data.

15. The computer-readable medium of claim 14, wherein the executable instructions further include instructions for analyzing the data, wherein the analyzing provides a breakdown of energy usage on a configurable per time basis.
